(19) United States
(12) Patent Application Publication
(10) Pub. No.: US 2018/0253722 A1
(43) Pub. Date: Sep. 6, 2018

(54) Electronic System and Method for Processing Merchandise Purchase Transactions

(71) Applicant: MASTERCARD INTERNATIONAL INCORPORATED, Purchase, NY (US)

(72) Inventor: Sudhir Gupta, Pune (IN)

(21) Appl. No.: 15/899,944

(22) Filed: Feb. 20, 2018

(30) Foreign Application Priority Data
Mar. 2, 2017 (SG) 10201701688P

(51) Int. Cl. G06Q 20/36; G06Q 40/02; G06Q 20/24

(52) U.S. Cl. CPC G06Q 20/36; G06Q 20/24; G06Q 40/025

(57) ABSTRACT

The present disclosure generally relates to an electronic system and method for processing a merchandise purchase transaction between a merchant and a consumer. The system comprises a server linked to a payment network and configured to receive, from a digital wallet of the consumer, transaction data comprising identification data of the merchant, data on cost of the merchandise, and details of a consumer payment instrument linked to the digital wallet. The server is also configured to determine a purchase credit line availed to the consumer; determine a loan amount from the purchase credit line to offset the merchandise cost; retrieve details of a financial account of the merchant based on the merchant identification data; and transfer the merchandise cost via the payment network to the merchant financial account. The server is then configured to communicate a reservation message to the merchant to reserve the merchandise for the consumer.

### CROSS-REFERENCE TO RELATED APPLICATION

This application claims the benefit of and priority to Singapore Patent Application No. 10201701688P filed Mar. 2, 2017. The entire disclosure of the above application is incorporated herein by reference.

### FIELD

The present disclosure generally relates to an electronic system and method for processing merchandise purchase transactions. More particularly, the present disclosure describes various embodiments of an electronic system and method for processing a merchandise purchase transaction, e.g., for purchase of goods, products, and/or services, between a merchant and a consumer.

### BACKGROUND

This section provides background information related to the present disclosure which is not necessarily prior art.

It is increasingly common for consumers to shop and make purchases from online merchant establishments instead of conventional brick-and-mortar merchant stores. Online shopping or electronic commerce (e-commerce) offers consumers the benefit and flexibility of browsing and purchasing a wide range of merchandise in the comfort of his/her home. Consumers may perform e-commerce transactions at online merchant establishments, such as websites, portals, mobile applications, or any other online platforms. The merchandise purchased from these e-commerce purchase transactions can be paid for by consumer payment instruments, such as payment cards, credit cards, or debit cards.

Furthermore, some consumers are using digital wallets to pay for purchase transactions with merchants. A digital wallet refers to or is linked to an electronic device, e.g., a mobile device or phone, which allows a consumer to make e-commerce transactions therewith. A payment instrument of the consumer, e.g., payment/credit/debit card, is linked to the digital wallet such that payments to merchants are made from the linked payment instrument. The digital wallet is operated on a software application executable on the consumer's electronic device.

While browsing for merchandise at the online merchant establishments or e-commerce websites, consumers may come across limited edition merchandise that is launched or available only for a specific time period. During certain occasions, such as Black Friday or flash sales, merchants may offer significant discounts off merchandise that the consumers may be interested to purchase. Consumers thus face a race against time to ensure they will be able to purchase the limited edition merchandise and/or discounted merchandise.

If a consumer is quick enough, he/she will be able to select the merchandise for purchase and proceed to pay for the merchandise with the digital wallet or payment instrument. However, it may happen that the payment instrument, e.g., credit card, has reached or exceeded the credit limit allocated to it. Or if the payment instrument is a debit card, the consumer may not have sufficient funds in the debit card to pay for the merchandise. As such, the consumer will not be able to complete the purchase transaction. This leads to a problem of the consumer losing the merchandise that he/she has selected as the merchandise may go out of stock or the discount period has expired by the time the consumer has restored his/her credit limit or has sufficient funds in the debit card. For some online merchant establishments, such as auction sites, consumers may have won the bid initially but eventually lose it because he/she does not have sufficient funds to pay the bid price. Time is wasted for the consumer as he/she has spent time searching for the merchandise to purchase online but does not have sufficient credit/funds to complete the purchase. Economically, this may represent loss of sales for the merchants, financial institutions that issued the payment cards, and payment card associations, such as MasterCard® and Visa®.

Therefore, in order to address or alleviate at least one of the aforementioned problems and/or disadvantages, there is a need to provide an electronic system and method for processing a merchandise purchase transaction, in which there is at least one improved feature over the aforementioned prior art.

### SUMMARY

This section provides a general summary of the disclosure, and is not a comprehensive disclosure of its full scope or all of its features. Aspects and embodiments of the disclosure are set out in the accompanying claims.

According to an aspect of the present disclosure, there is an electronic system, a method, and a non-transitory computer medium for processing a merchandise purchase transaction between a merchant and a consumer. The system comprises a server communicatively linked to a payment network, the server configured for performing steps of the method, comprising: receiving, from a digital wallet of the consumer, transaction data comprising identification data of the merchant, data on cost of the merchandise, and details of a consumer payment instrument linked to the digital wallet; determining, from a consumer database, a purchase credit line availed to the consumer by a financial loan instrument linked to the server; determining a loan amount from the purchase credit line to offset the merchandise cost; retrieving, from a merchant database, details of a financial account of the merchant based on the merchant identification data; and transferring the merchandise cost via the payment network to the merchant financial account, comprising: transferring the merchandise cost less the loan amount from the consumer payment instrument; and transferring the loan amount from the financial loan instrument; and communicating a reservation message to the merchant to reserve the merchandise for the consumer for a predefined time period.

An electronic system and method for processing a merchandise purchase transaction according to the present disclosure is thus disclosed herein. Various features, aspects, and advantages of the present disclosure will become more apparent from the following detailed description of the embodiments of the present disclosure, by way of non-limiting examples only, along with the accompanying drawings.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an electronic system for processing a merchandise purchase transaction, in accordance with an embodiment of the present disclosure.

FIG. 2 is an illustration of a computerized method for processing a merchandise purchase transaction, in accordance with an embodiment of the present disclosure.

FIG. 3 is an illustration of a settlement process, in accordance with an embodiment of the present disclosure.

FIG. 4 is an illustration of a settlement process, in accordance with another embodiment of the present disclosure.

FIG. 5 is an illustration of tables showing details of a merchandise purchase transaction, in accordance with an embodiment of the present disclosure.

FIG. 6 is a block diagram illustration of the technical architecture of a server of the electronic system of FIG. 1, in accordance with an embodiment of the present disclosure.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

### Overview

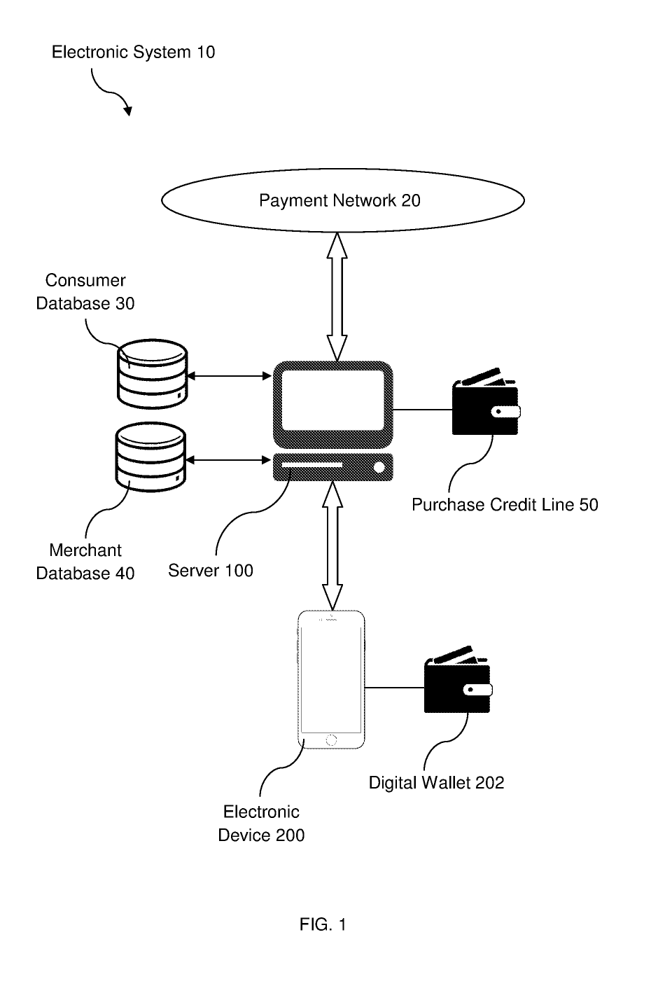

Broadly, as shown in FIG. 1, an electronic system 10 includes a server 100 configured for processing a merchandise purchase transaction between a merchant and a consumer. The server 100 firstly receives, from a digital wallet 202 of the consumer, transaction data including identification data of the merchant, data on cost of the merchandise, and details of a consumer payment instrument, e.g., credit card, linked to the digital wallet 202. The digital wallet 202 is communicatively linked to or installed on an electronic device 200 of the consumer. The server 100 then determines a purchase credit line 50 availed to the consumer by a financial loan instrument linked to the server 100. The purchase credit line 50 is independent of any credit limit associated with the payment instruments of the consumer. The server 100 then determines a loan amount from the purchase credit line 50 to offset the merchandise cost. The purchase credit line 50 allows the consumer to loan an amount from the purchase credit line 50 to supplement the funds or credit available in his/her credit card, especially when the credit card does not have a sufficient credit limit to pay for the merchandise. The loan amount may be determined by the consumer and input to the server 100 via the digital wallet 202, or automatically calculated by the server 100 based on the amount difference. The consumer can thus pay for the merchandise with the credit card and loan amount, and will not miss out on limited-edition or flash sale merchandise which would have occurred otherwise due to insufficient funds.

The server 100 then retrieves details of a financial account of the merchant based on the merchant identification data, and transfers the merchandise cost via a payment network 20 to the merchant financial account. Specifically, the merchandise cost less the loan amount is transferred from the consumer payment instrument to the merchant financial account, and the loan amount is transferred from the financial loan instrument (linked to the server 100) to the merchant financial account.

After successfully transferring the merchandise cost to the merchant financial account, the server 100 communicates a reservation message to the merchant to reserve the merchandise for the consumer for a predefined time period. The merchandise is reserved for the consumer until the loan amount is settled, and the consumer has the predefined time period, e.g., 24 hours, to settle or return the loan amount to the purchase credit line 50. By reserving the merchandise, the consumer can be assured that the merchandise will not be lost to another consumer if he/she does not have sufficient funds at the time of paying for the merchandise.

During the predefined time period, the merchandise purchase transaction is in a reserved status and the reserved merchandise is not available to other consumers. However, the reserved merchandise remains in the merchant's inventory and is not dispatched or released to the consumer. The reserved merchandise will be released to the consumer after the consumer settles the loan amount. If the consumer does not settle the loan amount after the predefined time period expires, the reservation of the merchandise is cancelled, and the merchandise is now available for other consumers to purchase. The merchandise purchase transaction is also reversed such that neither the consumer nor the financial loan instrument faces monetary losses.

Therefore, an advantage of utilizing the purchase credit line 50 is that the consumer can loan an amount from the purchase credit line 50 to supplement the funds or credit available in his/her credit card, especially when the credit card does not have sufficient credit limit to pay for the merchandise. The consumer can thus pay for the merchandise with the credit card and loan amount, and keep the merchandise reserved while the consumer makes an effort to repay the loan amount. The consumer thus will not miss out on limited-edition or flash sale merchandise which would have occurred otherwise due to insufficient funds.

### Description of Embodiments

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. As used herein, the term “set” corresponds to or is defined as a non-empty finite organization of elements that mathematically exhibits a cardinality of at least one (e.g., a set as defined herein can correspond to a unit, singlet, or single element set, or a multiple element set), in accordance with known mathematical definitions. The recitation of a particular numerical value or value range herein is understood to include or be a recitation of an approximate numerical value or value range.

For purposes of brevity and clarity, descriptions of embodiments of the present disclosure are directed to an electronic system and method for processing a merchandise purchase transaction, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure.

However, it will be recognized by an individual having ordinary skill in the art, i.e., a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In representative or exemplary embodiments of the present disclosure, there is provided the electronic system 10 as illustrated in FIG. 1. The system 10 includes the host server or server 100 having a processor and a memory configured to store computer-readable instructions. The server 100 is operative for performing a method for processing a merchandise purchase transaction between a merchant and a consumer, customer, or user. The system 10 includes an electronic device 200 of the consumer which is communicable with the server 100. The electronic device 200 may be a mobile device, such as mobile phones, smartphones, personal digital assistants (PDAs), tablets, laptops, and/or computers.

The system 10 further includes a payment network 20 communicatively linked to the server 100. It may alternatively be interpreted that the server 100 is communicatively linked such that it forms part of or is integrally connected within the payment network 20. In one embodiment, the payment network 20 and server 100 are operated by the same organization, specifically a payment organization or payment card/credit card association, such as MasterCard® or Visa®. In another embodiment, the payment network 20 is operated by a payment card association while the server 100 is operated by a financial institution or bank that forms part of the payment network 20.

The electronic device 200 is communicatively linked to a digital wallet 202 which allows the consumer to pay for the merchandise purchased in the purchase transaction with the merchant. The digital wallet 202, may also be termed as an electronic wallet or refers to an electronic device (e.g., the electronic device 200) that allows an individual to make electronic transactions. The digital wallet 202 may alternatively be referred to as an electronic wallet system or application that is embedded or installed on the electronic device 200, enabling the electronic device 200 to make electronic transactions. The electronic device 200 may thus be interpreted as being operative to function as the digital wallet 202.

The digital wallet 202 may be provided by a payment card association, such as MasterPass® by MasterCard®, or provided by a financial institution/bank, such as PayZapp™ by HDFC bank, or any other entity, such as financial technology solutions providers. A set of payment instruments, e.g., payment cards, of the consumer are linked to the digital wallet 202 such that payments to merchants are made from one of the linked payment instruments. The term “payment card” may refer to a credit card, debit card, prepaid card, or charge card which the consumer may use to pay for transactions. The term “payment instrument” may refer to any suitable cashless payment mechanism. In addition to payment cards, payment instruments may include, but are not limited to, membership cards, promotional cards, frequent flyer cards, identification cards, gift cards, and/or any other payment cards that may hold payment card information and which may be stored electronically, such as on the electronic device 200 of the consumer.

It will be appreciated that the digital wallet 202 may alternatively be configured to receive pre-paid funds or be recharged/reloaded with funds (e.g., from a financial or bank account of the consumer). In this way, the consumer may select an amount to pay into the digital wallet 202.

In one embodiment, the digital wallet 202 is hosted remotely on a computing system, e.g., on the server 100 or a separate cloud computing system, that is operated by a payment card association, a financial institution/bank, or a financial technology solutions provider. The digital wallet 202 can be accessed by the consumer by a software application, website, or any user interface (collectively referred to as “application”) using the electronic device 200 or any other electronic/digital device. The electronic device 200 is thus linked to the digital wallet 202 and the application enables the consumer to operate and control the digital wallet 202 therewith, including making payments for merchandise purchase transactions. In one example, the digital wallet 202 is remotely hosted on a computing system which is operative within a payment card association, and the digital wallet 202 may be linked to multiple payment/credit/debit cards issued by various financial institutions or banks that are members of the payment card association. In another example, the digital wallet 202 is remotely hosted on a computing system which is operative within a financial institution or bank, and the digital wallet 202 may be linked to a set of payment/credit/debit cards issued by the financial institution or bank.

In another embodiment, the digital wallet 202 is operative on the electronic device 200, such as via an application executable on the electronic device 200. Details of the digital wallet 202 are stored locally on the electronic device 200.

The payment network 20 connects or links together multiple financial institutions/banks. These financial institutions may be associated with financial/bank accounts of the merchant and/or associated with payment instruments of the consumer. Specifically, the payment network 20 is communicatively linked to a set of issuer financial institutions or banks. Each issuer bank is affiliated with the payment card association operating the payment network 20, and each payment card belonging to a consumer is issued by an issuer bank. The payment network 20 is communicatively linked to a set of acquirer financial institutions or acquirer banks. Similar to the issuer banks, each acquirer bank is also affiliated with the payment card association operating the payment network 20. Some financial institutions/banks may operate as both an acquirer bank and an issuer bank. For merchants to be able to accept cashless payments via payment cards, particularly from digital wallets 202, the merchants establish financial accounts with the acquirer banks.

It will be appreciated that the payment process within the payment network 20 and between the various financial institutions is standard and readily known to the skilled person.

The system 10 further includes a consumer database 30 and merchant database 40 communicatively linked to the server 100 for retrieval of data therefrom. The consumer database 30 stores consumer-related data, such as consumer profile details, transaction details, payment instruments details, transaction payment details, and credit scores of the consumers. The merchant database 40 stores merchant-related data, such as merchant profile details, transaction details, and merchant financial accounts details. Each of the consumer database 30 and merchant database 40 may reside on the server 100, or alternatively on a remote server or computer communicatively linked to the server 100.

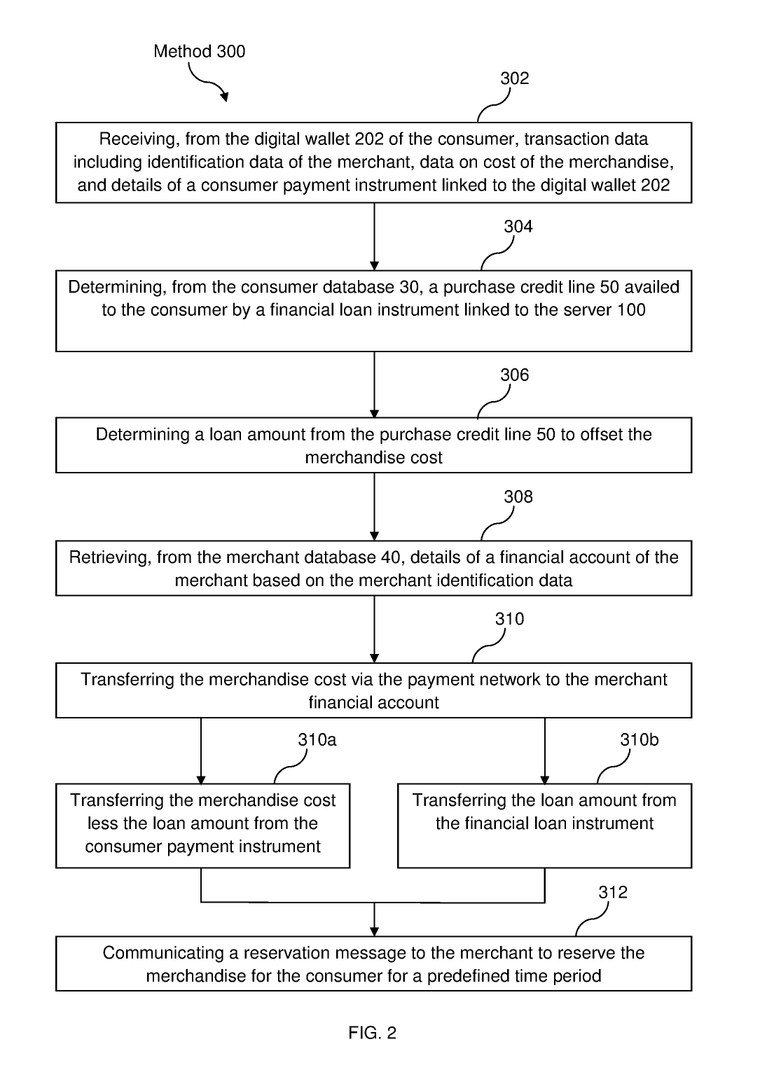

With reference to FIG. 2, there is shown a computer-implemented or computerized method 300, i.e., implemented on a computer or computer system, such as or including the server 100 communicatively linked to the payment network 20, for processing a merchandise purchase transaction between a merchant and a consumer. The term “merchandise” refers to goods, products, services, items, articles, etc., that are sold by merchants to consumers. The method 300 broadly includes:
a. a step 302 of receiving, from the digital wallet 202 of the consumer, transaction data including identification data of the merchant, data on cost of the merchandise, and details of a consumer payment instrument linked to the digital wallet 202;
b. a step 304 of determining, from the consumer database 30, the purchase credit line 50 availed to the consumer by a financial loan instrument linked to the server 100;
c. a step 306 of determining a loan amount from the purchase credit line 50 to offset the merchandise cost;
d. a step 308 of retrieving, from the merchant database 40, details of a financial account of the merchant based on the merchant identification data;
e. a step 310 of transferring the merchandise cost via the payment network to the merchant financial account, including:
   i. a step 310a of transferring the merchandise cost less the loan amount from the consumer payment instrument; and
   ii. a step 310b of transferring the loan amount from the financial loan instrument; and
f. a step 312 of communicating a reservation message to the merchant to reserve the merchandise for the consumer for a predefined time period.

In some embodiments, the server 100 is operative within a payment card association including or linking one or more financial institutions/banks, such that payments between the consumer and the merchant are conducted between the consumer's issuer bank and the merchant's acquirer bank through the payment network 20, wherein the server 100 functions as an intermediary between the consumer's issuer bank and the merchant's acquirer bank. In some other embodiments, the server 100 is operative within a financial institution, such as the consumer's issuer bank, such that payments between the consumer and the merchant are conducted directly between the consumer's issuer bank and the merchant's acquirer bank through the payment network 20. For purpose of brevity, it will be appreciated that details of payment processing between the issuer banks and acquirer banks are omitted as it is standard and readily known to the skilled person.

The consumer begins an online shopping process by firstly visiting an online establishment of a merchant to purchase some merchandise from the merchant. The consumer may visit the online merchant establishment using the electronic device 200, e.g., mobile phone, or a separate computing device, such as a laptop. Examples of such online merchant establishments include, but are not limited to, Amazon® and eBay®. A large selection of merchandise is presented to the consumer at the online merchant establishment and the consumer browses through to find the merchandise he/she wishes to purchase. Occasionally, the consumer may come across flash sales wherein merchandise is offered at significant discounts or limited-edition merchandise that is only sold for a limited time period. After selecting the merchandise into the online shopping cart, the consumer proceeds to the check-out page of the online shopping establishment. At the check-out page, the consumer selects a payment mode to pay for the merchandise and complete the merchandise purchase transaction. The check-out page offers a variety of payment modes, such as credit cards and bank transfers. More particularly, the check-out page offers a digital wallet option for the consumer. In embodiments of the present disclosure, the consumer selects the digital wallet option to pay for the merchandise with the digital wallet 202 that is linked to the electronic device 200.

In one embodiment, the consumer performs the online shopping process on the electronic device 200. Upon selection of the digital wallet option at the check-out page, the consumer is directed to the application executed on the electronic device 200. The application presents a user interface on the electronic device 200 for the consumer to perform actions to pay for and complete the merchandise purchase transaction. In another embodiment, the consumer performs the online shopping process on a different (second) computing device from the electronic device 200. Upon selection of the digital wallet option at the check-out page, a transaction identification number or code, e.g., matrix barcode or QR code, is generated and presented to the consumer on the second computing device. The application is executed on the electronic device 200 (which is linked to the digital wallet 202) and the generated transaction identification number or code is then input to the electronic device 200, e.g., by entering the transaction identification number or using a visual scanner of the electronic device 200 to scan the QR code. This identifies the merchandise purchase transaction which the digital wallet 202 is used to pay for.

Using the application on the electronic device 200, the consumer selects a consumer payment instrument linked to the digital wallet 202 to pay for the merchandise. After selecting the consumer payment instrument, the electronic device 200 initiates communication of transaction data from the digital wallet 202 to the server 100. Accordingly, in the step 302, the server 100 receives the transaction data from the digital wallet 202. The transaction data includes identification data of the merchant, data on cost of the merchandise, and details of the consumer payment instrument linked to the digital wallet 202. The transaction data may additionally include details, e.g., stock keeping unit (SKU) data, of the merchandise. In one embodiment, the cost of the merchandise is $3,000 and the consumer payment instrument is a credit card with an available credit limit of $2,000.

In the step 304, the server 100 determines the purchase credit line 50 that is availed to or extended to the consumer. The purchase credit line 50 is determined from the consumer database 30 by analyzing consumer-related data, such as consumer spending behavior/pattern and transactions history. For example, if the consumer has been consistently paying his/her credit card bills timely and/or has frequently made high-value purchases, the purchase credit line 50 availed to the consumer is higher. In one embodiment, the purchase credit line 50 availed to the consumer is $2,000. It will be appreciated that analysis of the consumer-related data to determine the purchase credit line 50 may be performed using predefined or known processes, algorithms, artificial intelligence, and/or machine learning, etc.

The purchase credit line 50 is given by a financial loan instrument that avails to the consumer an additional credit source or funding for purpose of paying for merchandise purchase transactions with the digital wallet 202. The financial loan instrument may be a financial account that is linked to or operated by the payment card association or financial institution/bank, which the server 100 is operative in. As such, the financial loan instrument is linked to the server 100 and the purchase credit line 50 availed by the financial loan instrument to the consumer is determined by the server 100. The purchase credit line 50 is independent of the credit limit associated with the payment instruments of the consumer. For example, if the credit card of the consumer has an available credit limit of $2,000, the purchase credit line 50 of $2,000 availed to the consumer is over and beyond that of the available credit limit.

In the step 304, in addition to the value or amount of the purchase credit line 50 availed to the consumer, the server 100 also defines a time period after which any utilized portion or amount of the purchase credit line 50 must be settled. The time period is defined based on data from the consumer database 30. For example, if the consumer has been consistently paying his/her credit bills on time, the time period may be longer. As such, the purchase credit line 50 can only be utilized by the consumer for the predefined time period. In one embodiment, the predefined time period is 24 hours. The purchase credit line 50 allows the consumer to loan an amount from the purchase credit line 50 to supplement the funds or credit available in his/her credit card, especially when the credit card does not have sufficient credit limit to pay for the merchandise. The consumer can thus pay for the merchandise with the credit card and loan amount, and keep the merchandise reserved while the consumer makes an effort to repay the loan amount. The consumer thus will not miss out on limited-edition or flash sale merchandise which would have occurred otherwise due to insufficient funds.

In some embodiments, the predefined time period is adjustable upon request by the consumer. The consumer may submit a request for extension to the server 100 for various reasons and this will be considered on a case-by-case basis, particularly in regard to the credibility of the request and of the consumer. In addition, the predefined time period may be correlated to the amount loaned from the purchase credit line 50. For example, if the consumer's loan is less than 50% of the purchase credit line 50, the predefined time period is 24 hours. If the consumer's loan is more than 50% of the purchase credit line 50, the predefined time period may be shorter, e.g., 12 hours.

Details of the available purchase credit line 50 are informed to the consumer via the application on the electronic device 200. The consumer then decides the amount of the available purchase credit line 50 to utilize. In one embodiment, the purchase credit line 50 is availed to the consumer for all merchandise purchase transactions, regardless of the merchandise cost and credit limit associated with the consumer payment instrument or credit card. In another embodiment, the purchase credit line 50 is availed to the consumer and can only be utilized if the merchandise cost is above the credit limit associated with the credit card. This can prevent inappropriate use or misuse of the purchase credit line 50, especially in cases wherein the consumer still has an available credit limit to pay for the merchandise.

In one embodiment, the merchandise cost is $3,000, the available credit limit is $2,500, and the available purchase credit line 50 is $2,000. The consumer needs another $500 because the available credit limit is insufficient to pay for the merchandise. In the step 306, the server 100 determines the loan amount from the purchase credit line 50. This loan amount is utilized to offset the merchandise cost, such that the amount paid with the consumer's credit card is less than the merchandise cost and the consumer can still purchase the merchandise. In one example, the server 100 automatically determines the loan amount by calculating based on the amount lacking, i.e., $500. In another example, the consumer manually inputs the loan amount of $500 via the application on the electronic device 200.

In another embodiment, all else unchanged, the available credit limit is $3,500. The consumer need not loan from the purchase credit limit but may decide to loan a $500 amount to supplement the credit card. The consumer manually inputs the loan amount of $500 via the application on the electronic device 200.

Accordingly, if the initial merchandise cost is $3,000 and the loan amount from the purchase credit line 50 is $500, the offset merchandise cost becomes $2,500. The loan amount of $500 is loaned from the purchase credit line 50 for a predefined time period of 24 hours. It will be appreciated that the predefined time period may be different, e.g., depending on the loan amount.

In the step 308, the server 100 retrieves, from the merchant database 40, details of a financial account of the merchant based on the merchant identification data. The merchant database 40 stores financial accounts details of various merchants identifiable by the merchant identification data received in the step 302. Details of the merchant financial data are retrieved so that funds for the merchandise purchase transaction can be transferred thereto.

In the step 310, the server 100 transfers the merchandise cost via the payment network 20 to the merchant financial account. Specifically, the server 100 performs the step 310a of transferring the merchandise cost less the loan amount, i.e., equaling the offset merchandise cost, from the credit card to the merchant financial account, and the step 310b of transferring the loan amount from the financial loan instrument to the merchant financial account. The steps 310a and 310b may be performed simultaneously or sequentially. In one embodiment, $2,500 is transferred from the credit card to the merchant financial account in the step 310a, and $500 is transferred from the financial loan instrument to the merchant financial account. The merchant financial account thus receives a total amount of $3,000 equaling the merchandise cost. It will be readily understood that the payment process may be completed in a standard manner which may involve various parties of the payment network 20, such as the issuer and acquirer banks of the consumer and merchant, respectively. For example, in the step 310a, the server 100 communicates with the issuer bank of the consumer's credit card and the acquirer bank of the merchant financial account to transfer the merchandise cost.

After successfully transferring the merchandise cost to the merchant financial account, the server 100 performs the step 312 of communicating a reservation message to the merchant to reserve the merchandise for the consumer for the predefined time period. In one example, the server 100 communicates the reservation message directly to the merchant. In another example, the server 100 initiates or causes communication of the reservation to the merchant, such as via an intermediate third party or entity. Upon receiving the reservation message, the merchant reserves the merchandise for the consumer until the loan amount is settled, and the consumer has the predefined time period, e.g., 24 hours, to settle or return the loan amount to the purchase credit line 50. By reserving the merchandise, the consumer can be assured that the merchandise will not be lost to another consumer if he/she does not have sufficient funds at the time of paying for the merchandise. The loan amount allows the consumer to reserve and purchase merchandise that is more expensive than the available credit limit of his/her credit card.

During the predefined time period, the merchandise purchase transaction is in a reserved status and the reserved merchandise is not available to other consumers. However, the reserved merchandise remains in the merchant's inventory and is not dispatched or released to the consumer. Particularly, the rights to the merchandise temporarily belongs to, while the transaction is in the reserved status, the holder or owner of the financial account that is linked to the financial loan instrument giving the loan amount, such as the payment card association or financial institution/bank operating the server 100. In other words, while the transaction is in the reserved status, the consumer does not own the rights to the merchandise.

The reserved merchandise will be released to the consumer if the consumer manages to settle the loan amount within the predefined time period. This is to prevent misuse of the purchase credit line 50 for willful purchases. The rights holder can cancel the merchandise purchase transaction if the loan amount is not settled. Thus, if the consumer does not settle the loan amount after the predefined time period expires, the reservation of the merchandise is terminated or cancelled, and the previously reserved merchandise is now available for other consumers to purchase. The merchandise is only reserved for the predefined time period while the loan amount remains outstanding, so as not to unfairly prejudice other consumers and prevent them from purchasing the merchandise subsequently.

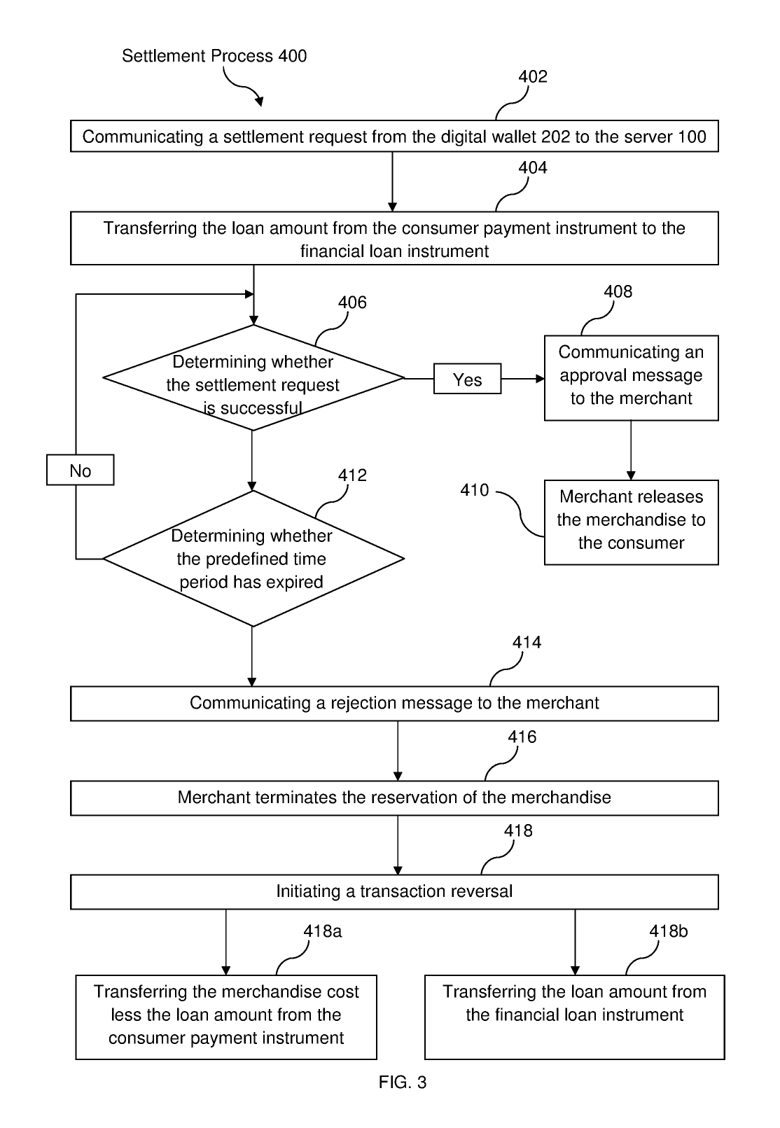

In some embodiments, the consumer takes action to settle the outstanding loan amount within the predefined time period. The consumer uses the application on the electronic device 200 to begin a settlement process 400. With reference to FIG. 3, the settlement process 400 includes a step 402 of communicating a settlement request from the digital wallet 202 to the server 100 for settlement of the loan amount. Notably, the consumer has to ensure that the digital wallet 202, or other payment instrument of the consumer, has sufficient funds or credit to settle the loan amount. For example, the loan amount is $500 and the consumer has paid off some outstanding bills on his/her credit card, such that the available credit limit (even after the merchandise purchase transaction) is above $500. Thus, the credit card has sufficient credit to settle the loan amount.

The settlement process 400, or more specifically the settlement request in the step 402, includes performing, by the server 100, a step 404 of transferring the loan amount from the consumer payment instrument (credit card) to the financial loan instrument (giving the purchase credit line 50). It will be readily understood that the transfer of the loan amount may be completed in a standard manner which may involve various parties of the payment network 20, including relevant issuer/acquirer banks of the credit card and financial loan instrument.

The settlement process 400 further includes performing, by the server 100, a step 406 of determining whether the settlement request is successful, i.e., whether the financial loan instrument has received the loan amount and the loan amount has been settled. In one embodiment, the step 406 is performed in response to completion of the step 404 of transferring the loan amount from the consumer payment instrument to the financial loan instrument. In another embodiment, the step 406 is performed upon expiry of the predefined time period. In yet another embodiment, the step 406 is performed periodically within the predefined time period.

If the settlement request is successful, i.e., the loan amount has been settled, the step 406 proceeds to a step 408 of communicating an approval message from the server 100 to the merchant. The approval message notifies the merchant that the loan amount has been settled and that the merchandise purchase transaction is now in an approved status. Particularly, the temporary owner of the rights to the merchandise informs the merchant that the transaction is now approved and that the rights are transferred to the consumer. The consumer now has the rights to the merchandise and may make modifications to the merchandise purchase transaction, such as changing of delivery address, if necessary.

In a subsequent step 410, the merchant proceeds to dispatch or release the merchandise to the consumer, e.g., by delivering the merchandise to an address of the consumer. A notification may be communicated from the merchant and/or server 100 to the consumer to inform him/her about the approval of the merchandise purchase transaction. The notification may be in the form of an email or a message displayed on the electronic device 200.

Conversely, if the settlement request is unsuccessful, i.e., the loan amount has not been settled, the step 406 proceeds to a step 412 of determining whether the predefined time period has expired. If the predefined time period has not expired yet, the step 412 returns to the step 406 of determining whether the loan amount has been settled. It will be appreciated that the step 406 may be performed iteratively within the predefined time period until the loan amount is settled. Notifications may be communicated periodically from the server 100 to the consumer to remind him/her to settle the loan amount.

If the predefined time period has expired, the step 412 proceeds to a step 414 of communicating a rejection message to the merchant. The rejection message notifies the merchant that the loan amount has not been settled within the predefined time period and that the merchandise purchase transaction is now in a rejected status. Particularly, the temporary owner of the rights to the merchandise informs the merchant that the transaction is now rejected and that the rights are returned to the merchant. In a subsequent step 416, the merchant proceeds to cancel or terminate the reservation of the merchandise, and the merchandise that was purchased by the consumer is now returned to the merchant's inventory and available for purchase by other consumers.

Additionally, the settlement process 400 includes a step 418 of initiating, by the server 100, a transaction reversal. Specifically, the transaction reversal reverses the earlier transfer of the merchandise cost to the merchant financial account. The transaction reversal includes a step 418a of transferring the merchandise cost less the loan amount, i.e., equaling the offset merchandise cost, from the merchant financial account to the consumer payment instrument (credit card), and a step 418b of transferring the loan amount from the merchant financial account to the financial loan instrument. The steps 418a and 418b may be performed simultaneously or sequentially. A notification may be communicated from the merchant and/or server 100 to the consumer to inform him/her about the rejection of the merchandise purchase transaction and details of the transaction reversal.

In one embodiment, the $2,500 that was previously transferred from the credit card to the merchant financial account is now transferred, i.e., returned or refunded, from the merchant financial account to the credit card in the step 418a, and the $500 that was previously transferred from the financial loan instrument to the merchant financial account is now transferred from the merchant financial account to the financial loan instrument. The merchant financial account thus returns or refunds a total amount of $3,000 equaling the merchandise cost. In another embodiment, the total amount of $3,000 is transferred from the merchant financial account to the financial loan instrument, and the $2,500 (belonging to the credit card) is subsequently transferred from the financial loan instrument to the credit card, thereby keeping $500 to restore the purchase credit line 50 to $2,000. In yet another embodiment, the total amount of $3,000 is transferred from the merchant financial account to an independent financial account which subsequently transfers the respective funds to the credit card and financial loan instrument.

The merchandise purchase transaction is thus reversed such that neither the consumer nor the financial loan instrument faces monetary losses or loses money as a result of the rejected transaction. It will be readily understood that the payment process may be completed in a standard manner which may involve various parties of the payment network 20.

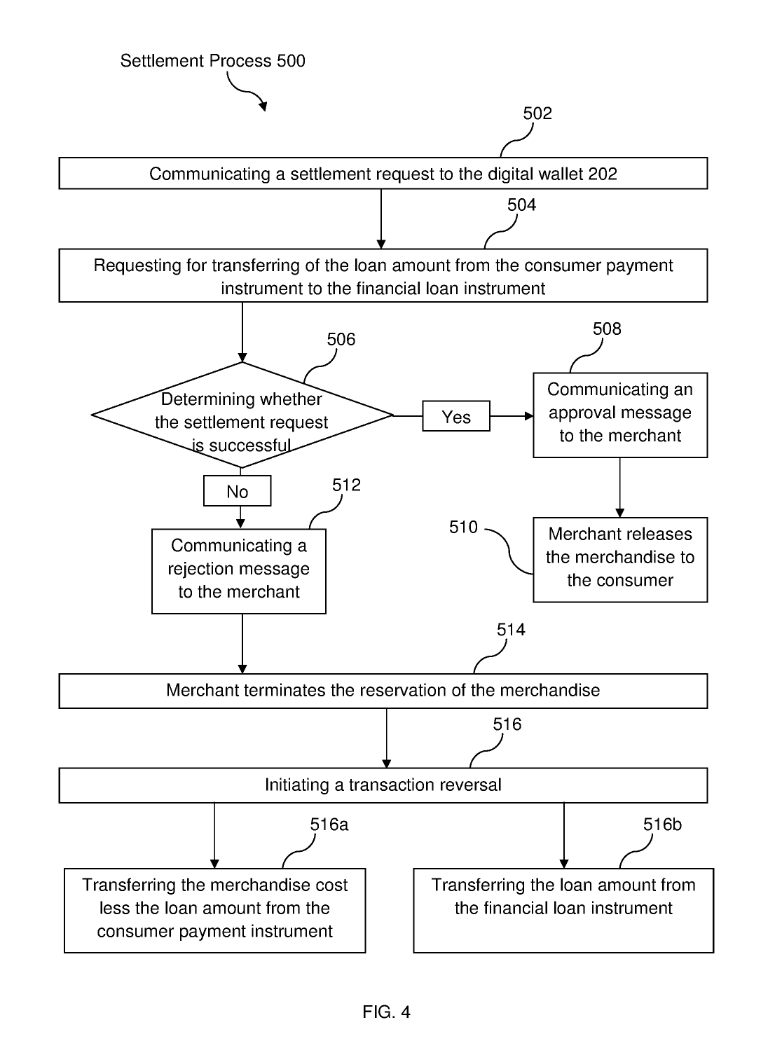

In some embodiments, the consumer does not take action to settle the outstanding loan amount within the predefined time period. The server 100 automatically performs a settlement process 500 upon expiry or at the end of the predefined time period. With reference to FIG. 4, the settlement process 500 includes a step 502 of communicating a settlement request to the digital wallet 202 for settlement of the loan amount. The settlement process 500, or more specifically the settlement request, includes a step 504 of requesting for transferring of the loan amount from the consumer payment instrument (credit card) to the financial loan instrument (giving the purchase credit line 50). Notably, the consumer has to ensure that the credit card has sufficient funds or credit to settle the loan amount by the end of the predefined time period. For example, if the consumer knows that his/her credit limit is insufficient to settle the loan amount, he/she may try to pay off some outstanding bills on the credit card during the predefined time period, such that the available credit limit (even after the merchandise purchase transaction) is above $500. This will give the credit card sufficient credit to settle the loan amount.

If there is sufficient credit on the credit card, the loan amount will be transferred from the credit card to the financial loan instrument. It will be readily understood that the transfer of the loan amount may be completed in a standard manner which may involve various parties of the payment network 20, including relevant issuer/acquirer banks of the credit card and financial loan instrument. The settlement process 500 further includes a step 506 of determining whether the settlement request is successful, i.e., whether the financial loan instrument has received the loan amount and the loan amount has been settled.

If the settlement request is successful, i.e., the loan amount has been settled, the step 506 proceeds to a step 508 of communicating an approval message from the server 100 to the merchant. The approval message notifies the merchant that the loan amount has been settled and that the merchandise purchase transaction is now in an approved status. In a subsequent step 510, the merchant proceeds to dispatch or release the merchandise to the consumer. A notification may be communicated from the merchant and/or server 100 to the consumer to inform him/her about the approval of the merchandise purchase transaction.

Conversely, if the settlement request is unsuccessful, i.e., the loan amount has not been settled, the step 506 proceeds to a step 512 of communicating a rejection message to the merchant. The rejection message notifies the merchant that the loan amount has not been settled within the predefined time period and that the merchandise purchase transaction is now in a rejected status. In a subsequent step 514, the merchant proceeds to cancel or terminate the reservation of the merchandise.

Additionally, the settlement process 500 includes a step 516 of initiating, by the server 100, a transaction reversal. Similar to the step 418 described above, the transaction reversal includes a step 516a of transferring the merchandise cost less the loan amount from the merchant financial account to the consumer payment instrument, and a step 516b of transferring the loan amount from the merchant financial account to the financial loan instrument. A notification may be communicated from the merchant and/or server 100 to the consumer to inform him/her about the rejection of the merchandise purchase transaction and details of the transaction reversal.

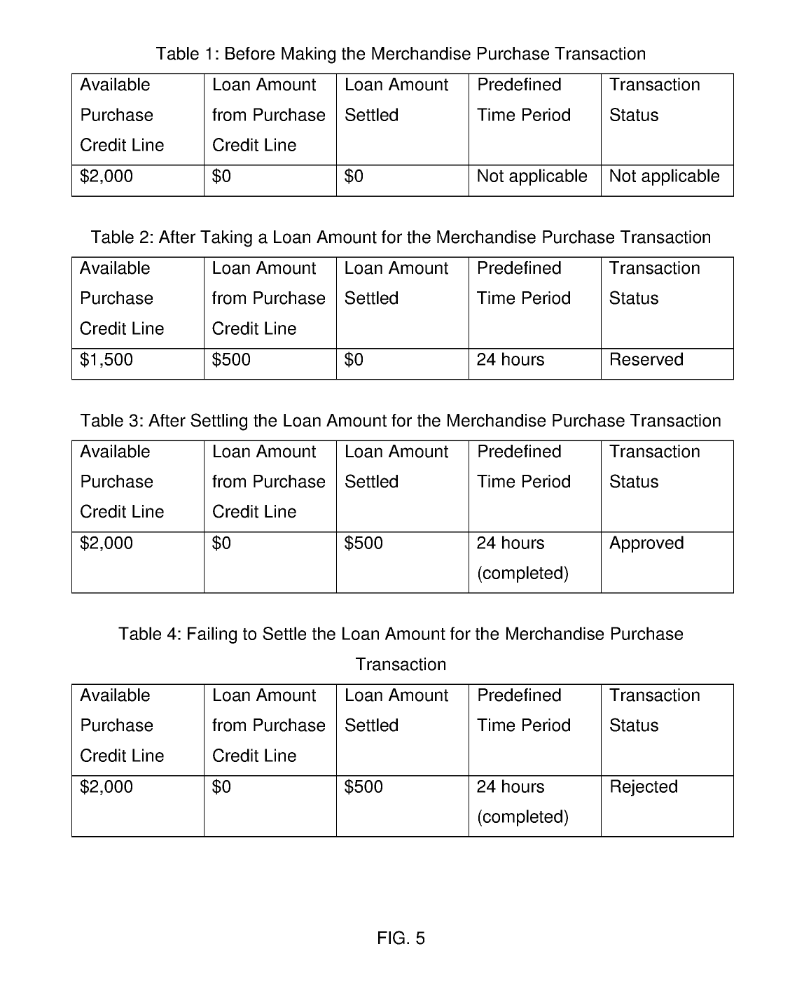

In some embodiments, details of the merchandise purchase transaction are retrievable by the consumer with the application and displayed on the electronic device 200. The details may be displayed in a tabular format as shown in in FIG. 5 as Tables 1 to 4.

It will be appreciated that the tables may include additional details including, but not limited, to the merchandise cost, type or selection of consumer payment instrument, and amount utilized from the consumer payment instrument, etc. Furthermore, details of the predefined time period may be shown in the form of a countdown timer, so that the consumer is updated on the remaining time to settle the loan amount.

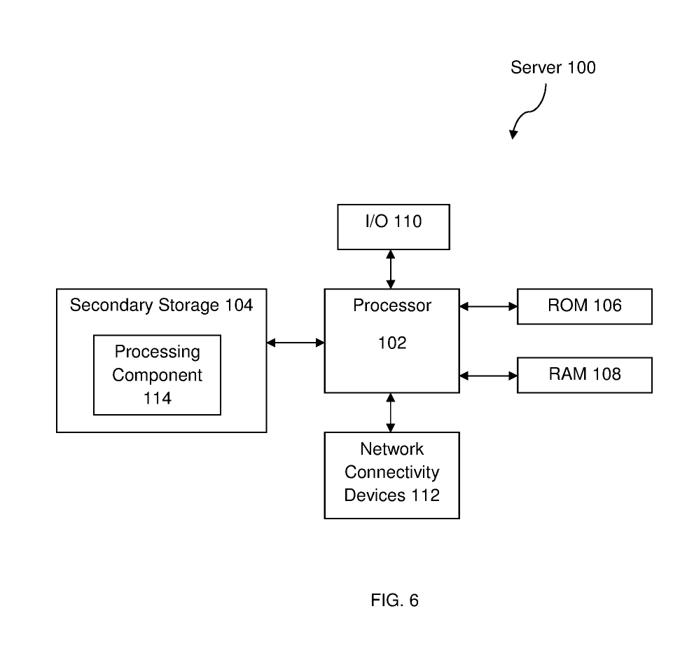

The following is a description of the technical architecture of the server 100 with reference to FIG. 6. The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 300 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 300 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols, such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

In the foregoing detailed description, embodiments of the present disclosure in relation to an electronic system and method for processing a merchandise purchase transaction are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic system for processing a merchandise purchase transaction between a merchant and a consumer, the system comprising:
a server communicatively linked to a payment network and configured to:
receive, from a digital wallet of the consumer, transaction data comprising identification data of the merchant, data on cost of the merchandise, and details of a consumer payment instrument linked to the digital wallet;
determine, from a consumer database, a purchase credit line availed to the consumer by a financial loan instrument linked to the server;
determine a loan amount from the purchase credit line to offset the merchandise cost;
retrieve, from a merchant database, details of a financial account of the merchant based on the merchant identification data;
transfer the merchandise cost via the payment network to the merchant financial account by transferring the merchandise cost less the loan amount from the consumer payment instrument and transferring the loan amount from the financial loan instrument; and
communicate a reservation message to the merchant to reserve the merchandise for the consumer for a predefined time period.

2. The electronic system according to claim 1, wherein the server is further configured to receive, within the predefined time period, a settlement request from the digital wallet for settlement of the loan amount.

3. The electronic system according to claim 2, wherein the server is configured, in connection with receiving the settlement request, to transfer the loan amount from the consumer payment instrument to the financial loan instrument.

4. The electronic system according to claim 3, wherein the server is further configured to communicate an approval message to the merchant upon settlement of the loan amount, thereby releasing the merchandise to the consumer.

5. The electronic system according to claim 1, wherein the server is further configured to communicate upon expiry of the predefined time period, a settlement request to the digital wallet for settlement of the loan amount.

6. The electronic system according to claim 5, wherein the settlement request comprises a request to transfer the loan amount from the consumer payment instrument to the financial loan instrument.

7. The electronic system according to claim 6, wherein the server is further configured to communicate an approval message to the merchant if the settlement request is successful, thereby releasing the merchandise to the consumer.

8. The electronic system according to claim 6, wherein the server is further configured to communicate a rejection message to the merchant if the settlement request is unsuccessful, thereby cancelling the reservation of the merchandise for the consumer.

9. The electronic system according to claim 8, wherein the server is further configured to initiate a transaction reversal if the settlement request is unsuccessful.

10. A computerized method implemented on a server for processing a merchandise purchase transaction between a merchant and a consumer, the server communicatively linked to a payment network, the method comprising:
receiving, from a digital wallet of the consumer, transaction data comprising identification data of the merchant, data on cost of the merchandise, and details of a consumer payment instrument linked to the digital wallet;
determining, from a consumer database, a purchase credit line availed to the consumer by a financial loan instrument linked to the server;
determining a loan amount from the purchase credit line to offset the merchandise cost;
retrieving, from a merchant database, details of a financial account of the merchant based on the merchant identification data;
transferring the merchandise cost via the payment network to the merchant financial account, comprising:
transferring the merchandise cost less the loan amount from the consumer payment instrument; and
transferring the loan amount from the financial loan instrument; and
communicating a reservation message to the merchant to reserve the merchandise for the consumer for a predefined time period.

11. The method according to claim 10, further comprising receiving, within the predefined time period, a settlement request from the digital wallet for settlement of the loan amount.

12. The method according to claim 11, wherein receiving the settlement request comprises transferring the loan amount from the consumer payment instrument to the financial loan instrument.

13. The method according to claim 12, further comprising communicating an approval message to the merchant upon settlement of the loan amount, thereby releasing the merchandise to the consumer.

14. The method according to claim 10, further comprising communicating, upon expiry of the predefined time period, a settlement request to the digital wallet for settlement of the loan amount.

15. The method according to claim 14, wherein communicating the settlement request comprises requesting for transferring of the loan amount from the consumer payment instrument to the financial loan instrument.

16. The method according to claim 15, further comprising communicating an approval message to the merchant if the settlement request is successful, thereby releasing the merchandise to the consumer.

17. The method according to claim 15, further comprising communicating a rejection message to the merchant if the settlement request is unsuccessful, thereby cancelling the reservation of the merchandise for the consumer.

18. The method according to claim 17, further comprising initiating a transaction reversal if the settlement request is unsuccessful.

19. The method according to claim 18, wherein initiating the transaction reversal comprises:
transferring the merchandise cost less the loan amount from the merchant financial account to the consumer payment instrument; and
transferring the loan amount from the merchant financial account to the financial loan instrument.

20. A non-transitory computer-readable medium storing computer-readable instructions that, when executed, cause a processor of a server, in connection with processing a merchandise purchase transaction between a merchant and a consumer, to:
receive, from a digital wallet of the consumer, transaction data comprising identification data of the merchant, data on cost of the merchandise, and details of a consumer payment instrument linked to the digital wallet;
determine, from a consumer database, a purchase credit line availed to the consumer by a financial loan instrument linked to the server;
determine a loan amount from the purchase credit line to offset the merchandise cost;
retrieve, from a merchant database, details of a financial account of the merchant based on the merchant identification data;
transfer the merchandise cost via the payment network to the merchant financial account by transferring the merchandise cost less the loan amount from the consumer payment instrument and by transferring the loan amount from the financial loan instrument; and
communicate a reservation message to the merchant to reserve the merchandise for the consumer for a predefined time period.
